(19) United States
(12) Patent Application Publication
(10) Pub. No.: US 2012/0170523 A1
(43) Pub. Date: Jul. 5, 2012

(54) SCALABLE VIDEO SENDER OVER MULTIPLE LINKS

(76) Inventor: Mehmet Reha Civanlar, Istanbul (TR)

(21) Appl. No.: 12/982,736

(22) Filed: Dec. 30, 2010

(51) Int. Cl. H04W 72/04; H04W 4/00

(52) U.S. Cl. 370/329; 370/328

(57) ABSTRACT

Disclosed are a system and method to efficiently send layered media, for example SVC encoded video, over parallel multiple wireless links (of one or more operator's networks) using a serving model, by prioritizing transmission of High Priority packets over Low Priority packets of the media. Furthermore, each High Priority packet may be fragmented into fragments equal or less than the number of wireless links. Each fragment may be sent over an available wireless link, and if it can't be sent, it is resent over another available link repeating the resending over different links until success or packet expiration. The Low priority Packets, however, are not fragmented, and if they can't be sent on an available link, discarded.

### CROSS-REFERENCE TO RELATED APPLICATIONS

This application is related to U.S. patent application U.S. application Ser. No. 11/953,398, the disclosure of which is incorporated herein in its entirety.

### BACKGROUND INFORMATION

1. Technical Field

The disclosed subject matter relates to sending compressed digital video data over a set of bonded wireless wide-area connections in real-time. In particular, it relates to real-time transmission of the video information, which is encoded using scalable video coding (SVC) techniques, over multiple wireless wide-area links in connection with a novel packet queuing and serving model employed to reduce and/or minimize the negative effects of wireless data transmission problems on the received video quality. The system ensures that base layer of the SVC encoded video information is sent over multiple wireless links with enhanced and/or maximized probability of reception.

2. Background Art

Many TV channels rely on live (real-time) video coverage from the field. Such live video material includes interviews with people on the street or in their homes, broadcasting from event sites or from featured locations (such as in the travel channels) where establishing instant connectivity and providing sufficient bandwidth to send video in real-time may be problematic. Another application that requires live coverage from a mobile location is videoconferencing, for example, with corporate executives when they are on the road (e.g., in limousines). On-site trouble shooting using video material from the site that must be sent to another location for diagnosis, defense applications, remote surveillance, and medical applications that require a remote hospital's support for a surgery are a few other applications.

Deployment of the Third Generation (3G) wireless networks by mobile operators throughout the world accelerated the use of wireless video. The real-time video transport applications are bandwidth intensive and delay sensitive. Because of these specific properties of real-time video, carrying it on wireless networks that have unpredictable delay and throughput presents a great challenge. The 3G wireless networks and future generation networks being planned rely on the Internet protocol (IP) for data transmission, which enables multimedia Internet application such as VoIP, and video on demand over wireless networks. However, the transmission properties of the wireless network must be considered when using the network for real-time video transport. Typically, in mobile networks, the throughput and delay over a connection depend on the number of users served by the same base station and their current reception conditions, which are largely influenced by physical, geographical and environmental factors. In order to cope with the highly varying and unpredictable characteristics of mobile networks, different methods are needed to increase the robustness or video delivery and achieve a high quality video service.

Scalable Video Coding (SVC) is an extension of the H.264/AVC video coding standard, and is sometimes referred as layered coding. SVC has temporal, special and signal to noise ratio (SNR) scalability properties which make it much more suitable for transmission over channels such as mobile networks. A wide range of spatio-temporal and quality scalability can be achieved through the coding approach. As described in Prior Art, for example in [H. Schwarz, D. Marpe, T. Schierl and T. Wiegand, “Combined Scalability Support for the Scalable Extension of H.264/AVC,” Proc. of IEEE Int. Conf. on Multimedia and Expo (ICME), Netherlands, July 2005 and Y.-K. Wang, M. M. Hannuksela, S. Pateux, A. Eleftheriadis and S. Wenger, “System and Transport Interface of SVC,” IEEE Trans. on Circ. and Syst. for Video Tech., vol. 17, no. 9, pp. 1149-1163, 2007], an SVC bit stream may include a base layer data and zero, one, or more enhancement layers. From a purely transmission perspective, the base layer data may be classified as high priority (HP) whereas the enhancement layer can be classified as low priority (LP) because reception of the HP data is vital for reconstruction of intelligible video, whereas the LP enhancement layer data is not. The enhancement layers depend on the HP data and they can't be used without it. The removal of enhancement layers on the other hand may still produce a reasonable quality of decoded video.

The transport of SVC encoded video over a 3G mobile network may be achieved using the Internet protocol (IP) suites. For example, RTP over UDP can be used for real-time video. Achieving robust transmission on mobile networks using these protocol architectures has been a significant technical challenge. UMTS based mobile networks provide packet based bearers to distribute IP packets. Each IP packet is divided into fixed length bearer frames for transmission at the link layer. Improved robustness may be achieved by introducing Forward Error Correction (FEC) to each frame with a correction power adjusted to the channel conditions. At radio link layer, retransmission (ARQ) may be supported which may remedy cases where FEC fails as well. That is, the sub-IP protocol stacks of wireless networks favor as reliable delivery as possible considering the challenging physical conditions, at the expense of delay and throughput. However, even with these mechanisms commonly implemented, the packet loss rates of a practical mobile channel under heavily loaded conditions is still considerable due to timeouts.

Although 3G networks promise large bandwidths in the order of tens of Mbps, such rates are rarely experienced by ordinary users. High-quality video transmission services usually require a network throughput that is rarely supportable by a single wireless connection under typical cell-load conditions. Even when multiple links are used to transport video, there is no guarantee that desired robustness and video quality will be achieved even with SVC encoded video without the use of novel methods as proposed herein.

Certain techniques exist to bond multiple channels to obtain a higher bandwidth connectivity. Such bonded connections may be used to transmit compressed video to solve the throughput problem with a single connection. The product line described by Mushroom Networks [Mushroom Networks web site, http://www.mushroomnetworks.com], for example, offers options using bundled private lines such as T1s, Factional DS3s and DS3s, ADSL, wireless and cable lines to obtain a IP connectivity over such bundled lines, for small to medium enterprises, hotels and apartments. However, their technique only addresses general (media-unaware) data transport.

Transmission of IP packets over IP using multipath wireless connections have been studied, e.g. in Wei, Zakhor, “Multiple Tree Video Multicast Over Wireless Ad Hoc Networks”, IEEE CSVT Vol. 17 No 1, January 2007.

There is a body of performance modeling work by several universities to model video transport over wireline and wireless networks by taking into account the properties of video encoding and transport networks. For example, the work done by Y. Fan et al., [Yinglei Fan, et al. “A Network-aware Scalable Video Congestion Control Mechanism in Heterogeneous Wireless Networks”, Proceedings ICCGO 06, Bucharest, August 2006, page 20, ISBN: 0-7695-2690-X] evaluates the transport of SVC encoded video over wireless networks. However, this work does not address the distribution of video over multiple wireless links with different characteristics.

The research presented in [Ji-An Zha, et al. “Analysis of Priority Based Scheduling of Real-Time Video over 3G Wireless Networks”, Proceedings ISECS 2010], where the serving model for a wireless network uses the priority queuing, and where video arrival is modeled as different batch Markovian arrival processes for high and low priority video, is quite complicated and challenging to implement in real life. It relies on many simplifying assumptions that may not hold in real-world deployments.

H. Luo describes in [JongLi Luo, et al. “A Multi-Buffer Scheduling Scheme for Video Streaming”, Proceedings ICMCS 2005, pp 1218-1221, Amsterdam, 2005.] the use of multiple buffers for serving high priority and low priority data of scalable video with a transport network, but has not addressed the special properties of a wireless networks.

A summary of various protocols and technical challenges of scalable video over mobile networks is provided in [Thomas Schierl, et al., “Mobile Video Transmission Using Scalable Video”, IEEE Transactions on Circuits and Systems for Video Technology, Special Issue on Scalable Video Coding, vol. 17, no. 9, pp. 1204-1217, September 2007, Invited Paper].

### SUMMARY

Systems and methods for sending layered media over a communication system with multiple links are disclosed herein. In some embodiments, a method for sending layered media over a communication system with multiple links includes distinguishing between BL and EL packets; prioritizing BL packets over EL packets; fragmenting at least one BL packet into a plurality of fragments B1, B2, . . . , Bn; sending a B fragment over an available link, and if it can't be sent and has not yet expired, resending it over another available link and repeating resending until success or expiration; and sending an EL packet over an available link, and if it can't be sent, discarding it.

### BRIEF DESCRIPTION OF THE DRAWINGS

FIG. 1 is an exemplary block diagram of a network setup with multiple wireless links according to an embodiment of the invention;

FIG. 2 shows exemplary prioritization logic carried out by the priority scheduler of FIG. 1;

FIG. 3 is an example of the operation of the Priority Queuing Based Serving System according to the exemplary algorithm of FIG. 2;

FIG. 4 shows an exemplary procedure carried out by the Multi-Link Frame Distributor of FIG. 1; and

FIG. 5 shows an exemplary sequence corresponding to the PS output buffer of FIG. 3.

Throughout the drawings, the same reference numerals and characters, unless otherwise stated, are used to denote like features, elements, components or portions of the illustrated embodiments. Moreover, while the disclosed subject matter will now be described in detail with reference to the figures, it is done so in connection with the illustrative embodiments.

### DETAILED DESCRIPTION

Disclosed are a system and method to efficiently send layered media, for example SVC encoded video, over multiple links using a simple and practical serving model, by taking into account the properties of High Priority (HP) and Low Priority (LP) data produced, for example, by a scalable codec, such as a codec compliant with ITU-T Rec. H.264 Annex G, informally known as Scalable Video Coding or SVC. The links can include segments of wide area networks and/or wireless networks, such as those provided by cellular communication, 3G, 4G, and the like. While the system and method can be particularly responsive to the properties of wireless transmission in multi-operator scenarios, they can also provide advantages when communicating over more than one link using non-guaranteed quality of service. In order to simplify the presentation of the disclosed subject matter, the description refers only to wireless links henceforth.

One property of the wireless business ecosystem noticeable in the context of this disclosure is that wireless links can belong to a different mobile service provider, also known as operator. Using wireless links belonging to more than one operator can eliminate the competition between the links handled by a common shared air resource, such as the base station operated by a single operator. In other words, if more than one link were used and those links belong to different operators, they can use different spectrum resources, which are independent form each other.

Connections originating from the same geographic location in an operator's network can use the same base-station, and, therefore, may share the same network resources. As a result, the throughput does not scale linearly with the number of connections to the same operator from the same location, especially for heavily loaded cells. Moreover, those connections going through the same physical path suffer from similar physical degradations. As a result, any degradations of the signal quality due to local factors such as building obstructions can affect all connections between the sending device and the (single) base station. Connections to different operators are more likely to use base stations at different geographical locations, thereby providing for spatial diversity. Finally, at any given time, the load of a base station may be different between operators as there can be different number of active users in each operator's cell.

As a result, when more than one link serviced by different operators is involved, it is likely that those different links offer a different service quality at any given instance in time.

While wireless cellular phone link scenarios are suitable for the techniques disclosed herein, other network architectures may offer similar properties suitable for use of the disclosed techniques. For example, if a house were connected to the Internet using two independent connections, at least one of which has a variable service quality, at any given instance in time it is possible to determine the “better” link and the “worse” link.

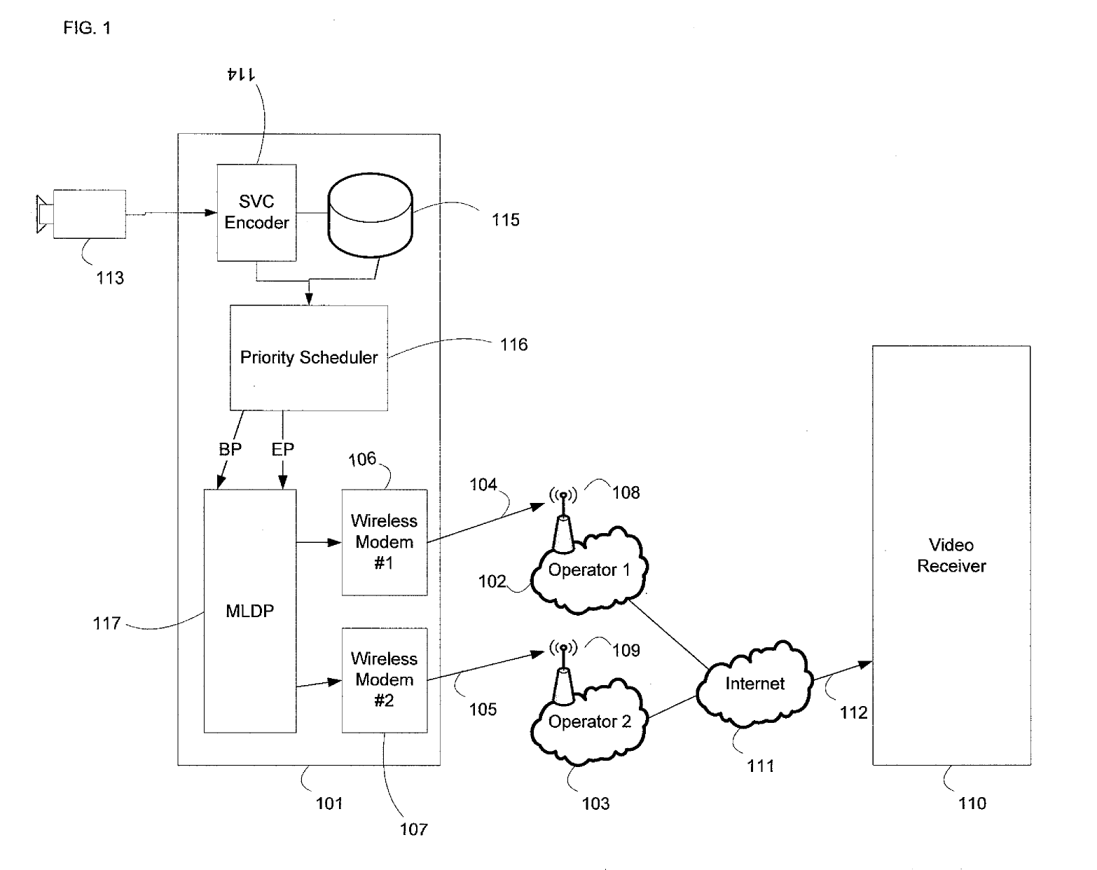

FIG. 1 depicts a system according to an embodiment of the present invention. A video sender (101) is attached to two operator's wireless networks, (102) and (103), using two wireless links (104) and (105), between two wireless modems (106) (107) in the sender and two base stations (108) (109) in the operator's networks (102) (103). The operator networks (102) (103) are connected to the Internet or any other suitable network (111). A video receiver (110) is connected to the Internet (111) through a single or multiple wireline link (112), and receives video from the video sender. The specific internal architecture of the video receiver is not crucial to the disclosed subject matter, as long as the video receiver can take advantage of the layered nature of the video bitstream; advantageously, the video receiver should be able to decode and reproduce the base layer packets (see below) without using the enhancement layer packets.

The video sender (101) may receive uncompressed video from a camera (113), which can be encoded by an SVC video encoder (114) into a scalable bitstream. The scalable bitstream can be sent without further buffering, or it can be stored in a video database (115). The system can include two modules: a priority queuing and serving logic, aka priority scheduler (116); and a multi-link distribution process (MLDP) module (117). The priority sender (116) is configured to receive the scalable bitstream from the encoder (114) or the video database (115), differentiate between, queue, and serve, Base Layer (BL) Packets and Enhancement Layer (EL) Packets, where the Base Layer Packets are of high priority and the enhancement layer packets are of low priority. The multi-link distribution process (MLDP) module (117) can distribute the video bits to the wireless links in accordance with disclosed subject matter.

Having reviewed the basic system layout, disclosed now are techniques that allow to address two deficiencies wireless networks expose when used to transmit video: (1) delay and delay jitter, and (2) throughput and robustness.

Delay is an important performance metric. Various components of a video transmission system, including video sender and video receiver and the networks connecting the two, contribute to the delay. Sources of delay include:
Video encoder processing and buffers;
Wireless transport network;
Wired transport network such as the Internet;
Video decoder processing and buffers.

To simplify the discussion, among these delay components, the wired network delay is henceforth assumed to be negligible compared to other delay components. The delay introduced by the video encoder and decoder, both buffering and processing, are further assumed to be deterministic and related to implementation of these components. Under these assumptions, the only time varying and probabilistic aspect of total delay stems from the wireless connections. It should be noted that the disclosed subject matter is similarly applicable if the delays resulting from video processing, buffering, and wireline transport are not negligible, or deterministic.

Timely delivery of video packets is important because video data packets must be delivered to the decoder before their contents can be displayed. The time varying delay component has to be factored into the process of video service delivery to ensure video packets that have already expired (as the time for the decoding and playout has passed) are not delivered, so as to avoid wasting network resources.

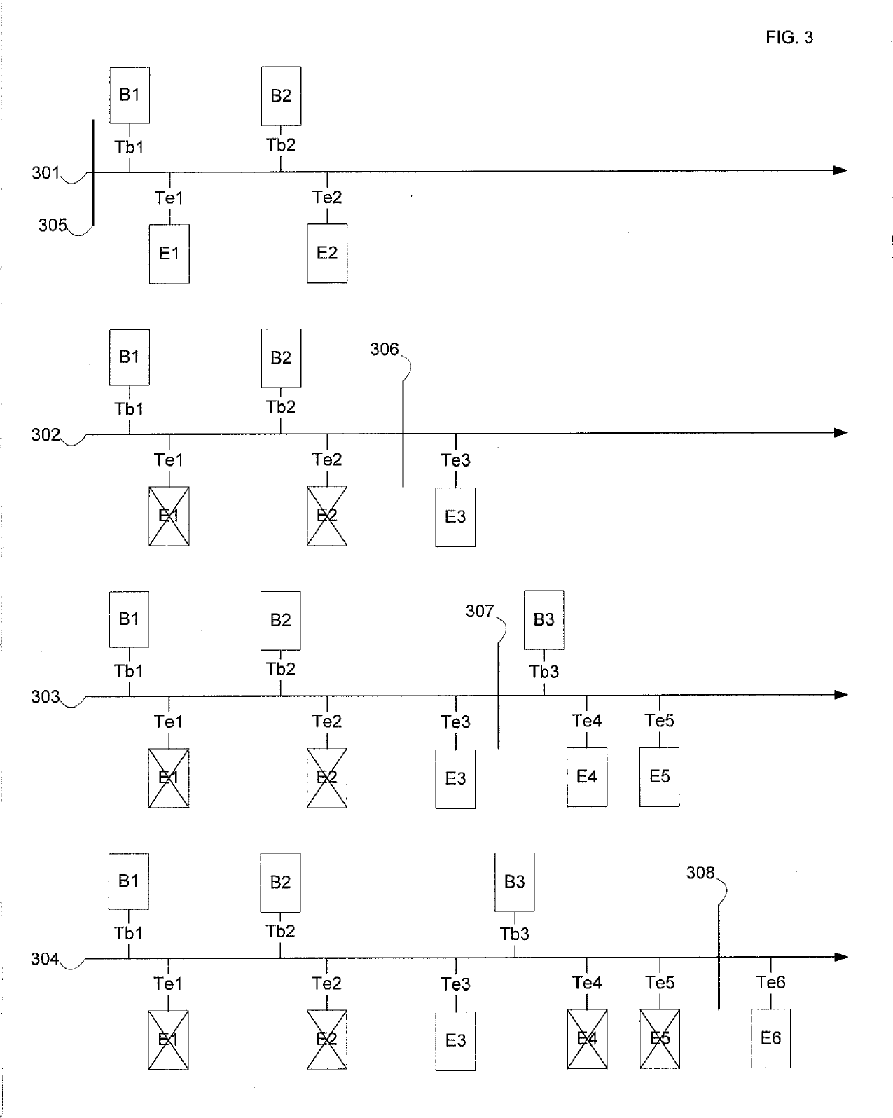

In one exemplary embodiment of the invention, the priority queuing process of the video server handles the servicing of Base Layer (BL) packets and Enhancement Layer (EL) packets by considering their expiration timers. A dual queue service model is used in the description, although it should be obvious for a person skilled in the art that more than two queues could be used as well, especially when differentiating between more than two priority levels. (Using more than two queues may require using more than two transmission paths, wireless models, base stations, operator networks, and so on.) Two buffers are allocated in the video sender, one of BL packets and another for EL packets. Associated with each BL and EL packet there is an expiration time as illustrated in FIG. 3. This expiration time for the i^{th} packet, Tᵢ, can be expressed as:

Tᵢ=T₀+Time-Stamp(i)

where, T₀ is a reference to wall-clock time agreed between sender and receiver. T₀ may be the actual wall clock time at which the video receiver is supposed to display the data in the very first packet of the video being transmitted. The video sender has to know T₀ which can be obtained through a direct feedback from the video receiver, or using a buffering process agreed upon beforehand. One common technology of establishing T₀ is the use of Real Time Transport Control Protocol's (RTCP's) sender/receiver report system.

Further, time synchronization between the client and the server is assumed, and can be implemented through well known techniques. That is, increases in the time stamp refers to essentially the same time interval in both sender and receiver. One known technique to establish such synchronization is the use of a phased locked loop (PLL).

Time-Stamp(i) is the time at which the data in the packet need to be available to a decoder assuming that T₀=0. It is related to the frame number for which the data in the packet will be needed and the encoder properties (e.g., reference frames may need to be decoded before the frames that use them.)

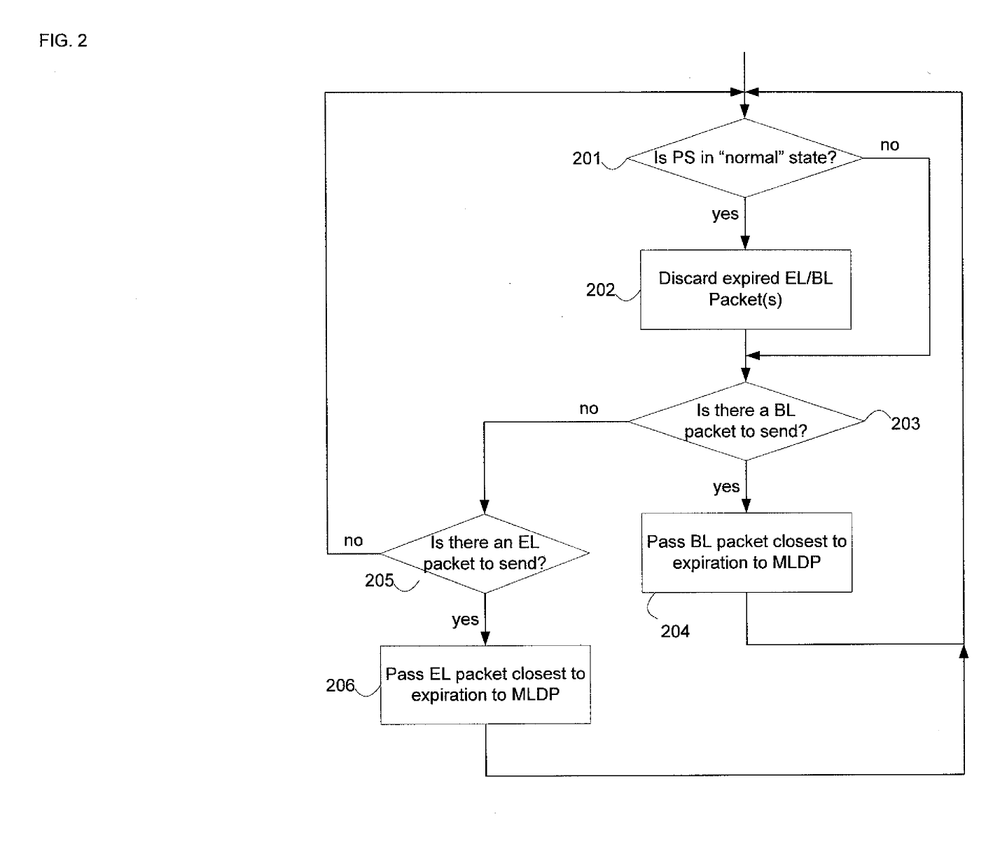

Referring to FIG. 2, depicted is a simplified flowchart of the steps carried out by priority scheduler (PS) (116) of FIG. 1. It prioritizes the BL packets and discard packets with expired timers. Under normal operation, i.e., when the receiver continues the playback without slowing down or pausing, T₀ can remain unchanged. This state is referred as ‘normal state’. In the normal state (step 201), the scheduler checks to determine if there are expired packets in the queue, and discards them (step 202). Thereafter, PS checks to determine if there are BL packets to send (step 203), and, if there are, it passes the BL packet closest to expiration to MLDP (117) (step 204). If there are no BL packets, PS checks if there are any EL packets to send (step 205), and if there are, it passes the one closest to expiration to MLDP (step 206) and returns to the beginning, step 201.

If the receiver pauses or slows down the play-back because of, e.g., handling receiver buffer depletion due to network problems, then T₀, and hence, all the expiration times should be updated accordingly. The new value of T₀ should be determined at the time when the receiver returns to the normal play-back and is equal to T₀ plus the time elapsed during the pause or the elapsed time multiplied by the play-back slow-down factor in case of a slow-down. If and when the receiver decides to pause or slow-down, it should inform the transmitter about this event immediately so that the scheduler stops discarding packets by deactivating packet expirations by e.g., setting the current time to infinity.

Shown in FIG. 3 is an example sequence of BL packets (referred as ‘B’) and EL packets (referred as ‘E’) received by the PS at different times with expiration time stamps, and the resultant set of serviced packets according to the algorithm of FIG. 2. The figure shows four timelines, (301), (302), (303), and (304), of the same exemplary PS sending scenario.

In timeline (301), the PS has received four packets: B1, B2 are base layer packets, whereas E1 and E2 are enhancement layer packets. The position of the packet indicates the value of the expiration timer of each packet. The bold vertical bar (305) indicates the instance in time when the PS is making its determination of the sequencing of the packets.

As B1 and B2 are in the queue, they receive priority over E1 and E2, even if E1, for example, was queued earlier than B2.

In the second timeline (302), packets B1 and B2 have successfully been forwarded for sending (according to mechanisms discussed later). E1 and E2, however, could not be served at the time instance of the next PS operation (determined by the “business” of the sending operation, as discussed later), again indicated by a vertical, bold bar (306), because their expiration time is earlier than the operation of the PS. Therefore, they were discarded. However, at this point in time, the PS queue has received another packet, E3, for processing. Its expiration time is still in the future (the packet is located to the right hand of the bold bar), and therefore it is being forwarded for sending.

In the third timeline (303), at the time the PS is run, packet E3 has successfully been forwarded for sending, and three more packets are waiting in the queue for processing: B3, E4, and E5. B3 is immediately forwarded for sending as it is a base layer packet.

In the fourth timeline (304), at the time the PS is run, packet B3 has successfully been forwarded for sending, but packets E4 and E5 had to be discarded as their expiration time is past the operation of the PS (308). However, the only new packet in the queue, E6, is being sent now.

Note that with this priority based serving scheme, all BL packets (B1, B2, and B3) are served while some of the EL packets are served as well. At this step all serviceable BL and EL packets (B1, B2, E3, B3, and E6) are loaded into a buffer.

A slack time may be subtracted from T₀ in order to account for possible variations of the delay in the wireless networks and the modem cards.

Referring back to FIG. 1, the Multi-Link Distribution Process (MLDP) 117 shall be described next. It takes BPs and EPs as prioritized by the priority scheduler (116), and feeds the wireless modems (106) (107), thereby handling variations in network throughput and robustness.

One aspect of MLDP is that each BL packet is fractured into N packets if there are N wireless links attached to the video server. In the example setup of FIG. 1, N is equal to 2. The fracturing allows the MLDP logic to (1) simultaneously use all N wireless links for each BL packet, (2) retransmit only portions of a BL packet that fails to transmit—as opposed transmitting the entire packet—to save bandwidth, and (3) make available more bandwidth for EL packets.

The MLDP may receive each BL packet (‘B’) readily fractured by the video encoder into N packets (this requires the encoder to know the number of transmission channels and queues in use by the sender), or the video encoder may generate unfractured BL packets and the MLDP performs the fracturing. Although both approaches work, the first approach may be more preferable in real-time encoding cases as the video encoder can easily produce video units, such as slices, NAL units, or similar, according to the number of wireless connections, without requiring additional work at the MLDP. On the other hand, if the sender needs to send video from the video database, the MLDP can abstract from the details of the network topology by performing the fracturing. Note that if the MLDP fractures the BL packet, then the group of fractured BL packets corresponding to a BL packet send to the priority queuing is treated as one BL packet. Obviously, the expiration timer corresponding to a group of fractured packets corresponding to the same BL packet is the same.

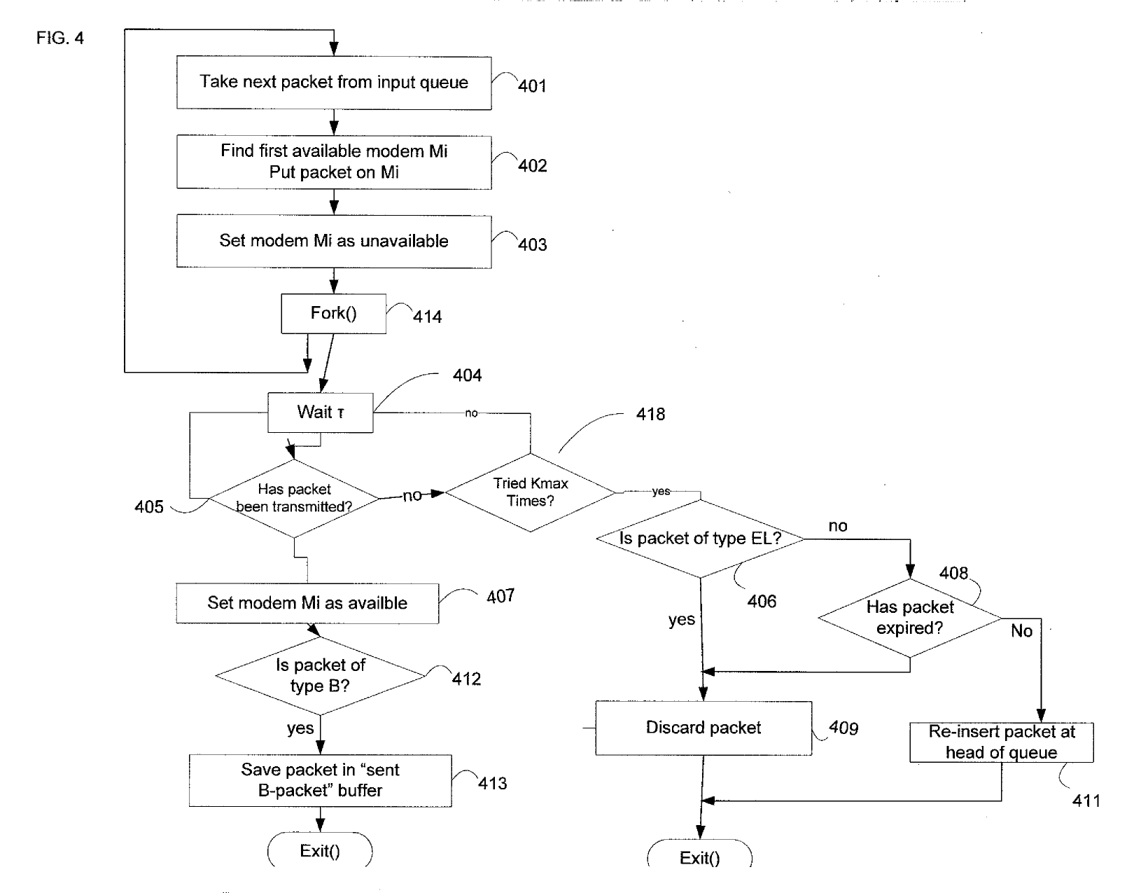

FIG. 4 shows an exemplary procedure carried out by the MLDP of FIG. 1 configured to serve multiple modem links.

This description relies on knowledge of certain functions available in Unix-like operating systems, which are in use in some PCs, smartphones, set-top-boxes, servers, certain system-on-a-chip architectures, and other devices. Specifically, one system call of Unix (and similar operating systems, such as Linux) is known as fork( ). fork( ) creates a new process by copying the complete state information of the process invoking fork( ). A process can learn whether it is the father or the child process by examining the return value of the function fork( ) if it is 0, the process is the father; if it is non-zero, the return value is the process ID of the child process. Multiple processes are often used in applications that need to execute several tasks in (semi-) parallel. Another call that is used in the description is exit( ). Exit( ) terminates a process.

If the BL packets passed from PS to MLDP are not readily in appropriately fractured form they must be fractured. If there are N modems in use, then each BL packet is fractured into N B packets as described above. Note that the EL packets are not necessarily fractured. All packets can be stored in the MLDP input queue to get serviced.

MLDP takes the first available packet from the queue (step 401), and searches for an available modem Mi. It puts the packet on Mi (step 402), After this, since Mi will be busy for some time transmitting the packet over the bandwidth-limited wireless link, its status is set to ‘unavailable’ (step 403). At this stage, the MLDP forks a child process and returns back to (step 401) to check if there is another packet awaiting servicing.

The child process waits for a specific time interval, τ, to allow for enough time for the modem, under good conditions, to transmit the packet (step 404) before checking whether the packet has been successfully transmitted from the modem's point of view (step 405). If the packet has been transmitted successfully, the status of Mi gets set to ‘available’ (step 407). Thereafter, the MLDP checks to determine if the just transmitted packet is a B packet (step 412). If yes, said packet is saved in the ‘sent-B-packet’ buffer (413) and the child process terminates. If the packet has not been transmitted successfully the MLDP checks to determine if the packet is an EL or B packet (step 406). If it is an EL packet, then it is discarded (step 409). If, however, the packet is a B packet, then MLPD checks to determine if the packet has expired (step 408). If the packet has expired it is discarded (step 409). If the B packet has not expired, then it is inserted into the head of the input queue (step 411) and the child process terminates.

The time interval, τ, of step 404 determines the frequency of polling the modem hardware to determine if the packet has been delivered. If it is set to zero, the polling frequency may be determined by the scheduler of the operating system. The maximum number of polls, Kₘₐₓ, of step 418, is a critical performance parameter and it can be set after experimentation or may be adapted during operation based on its short-time statistics. Alternatively, this process can be implemented through an interrupt driven mechanism where the child process, after delivering the packet to the modem hardware, sets up two interrupts and goes to sleep. The first interrupt may arrive from the modem hardware upon packet delivery, thereby waking-up the child process, which then continues with step 407. The second interrupt may be time driven in that, after a pre-set time, which is effectively equal to Kₘₐₓ times τ, it wakes-up the child process, forcing it to proceed with step 406.

Under an exception condition of too many unsuccessful trials of all links, the process can give a disconnect error.

In case an application layer ARQ mechanism is implemented, such as the one disclosed in U.S. application Ser. No. 11/953,398, the receiver may request a re-send for any part of a fractured B packet that has already been sent. In order to fulfill such requests, MLDP should keep copies of transmitted packets in a “sent-B-packet buffer” (413).

In one exemplary embodiment, MLDP can contain two processes for ARQ handling:

1. Re-transmit handler

2. Buffer cleaner

The re-transmit handler can be interrupt-driven and can be used to re-send the transmitted BL packets that are requested through ARQ. These packets are fetched from the said sent-B-packet buffer and inserted in the head of MLDP input queue.

The buffer cleaner process may clear the sent-B-packet buffer by discarding the expired packets in this buffer every time a new packet gets inserted. This daemon gets disabled in the no-discard state as all discards are deactivated.

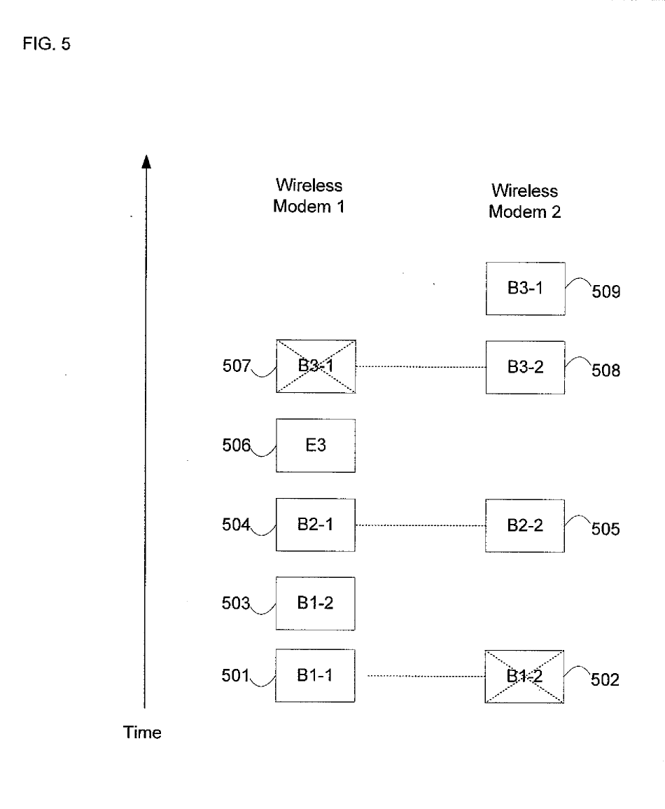

FIG. 5 shows an exemplary sequence corresponding to the PS output buffer of FIG. 3. In this sequence, a base layer packet B1 is fragmented into B11 and B12 and sent to Modems 1 and 2 respectively according to the MLDP mechanism described above. Specifically, B1-1 is sent by modem 1 (501) and modem 2 unsuccessfully tries to send B1-2 (502). Since modem 2 had no success in sending B1-2, but modem 1 was successful in sending B1-1, B1-2 is provided to modem 1 for processing and sent successfully (503). Of course, if the expiration timer for packet B1 would have expired by the time of sending B1-2 at modem 1 (503), the fragment would not have been sent but discarded.

The next base layer packet B2, again, is split into fragments B2-1 (504) and B2-2 (505), and sent over modem 1 and 2, respectively. Similarly, enhancement layer packet E3 is successfully sent over modem 1 (506).

Base layer packet B3 is once more split into fragments B3-1 (507) and B3-2 (508), and sent over modems 1 and 2, respectively. This time, modem 1 was not successful in sending B3-1 (507). Since B3 is not yet expired and because of the sent-failure of modem 1, B3-1 is sent over modem 2 (509).

The MLDP process of FIG. 4 is efficient as it relies on two fundamental principles:

If the modem handling an EL packet can't send it, that EL packet is simply discarded and not resent. Only one of the modems that have a successfully served packets before are used to service an EL packet to increase the chance of delivering that EL packet.

All modems are used in parallel to serve a BL packet to improve servicing probability. If any of the modems can't serve a portion of the BL packet, then MLDP resends it over a modem that has just successfully serviced a packet. Doing so, the transmission probability of entire BL packet is highly improved while the network load has not significantly increased with repetitive transmissions.

The foregoing merely illustrates the principles of the invention. Various modifications and alterations to the described embodiments will be apparent to those skilled in the art in view of the teachings herein. It will thus be appreciated that those skilled in the art will be able to devise numerous systems and methods which, although not explicitly shown or described herein, embody the principles of the invention and are thus within the spirit and scope of the invention.

What is claimed is:

1. A method of sending layered media over a communication system with multiple links, the method comprising:
distinguishing between BL and EL packets;
prioritizing BL packets over EL packets;
fragmenting at least one BL packet into a plurality of fragments B1, B2, . . . Bn;
sending a B fragment over an available link, and if it can't be sent and has not yet expired, resending it over another available link and repeating resending until success or expiration; and
sending an EL packet over an available link, and if it can't be sent, discarding it.

2. The method of claim 1, wherein the step of prioritizing BL packets over EL packets includes discarding at least one of expired BL packets and expired EL packets.

3. The method of claim 1, wherein the step of prioritizing BL packets over EL packets includes prioritizing BL packets with an expiration timer closest to an expiration over other BL packets.

4. The method of claim 1, wherein the sending of a packet involves waiting a pre-determined time.

5. The method of claim 1, wherein a BL packet is saved in a send B-packet buffer.

6. A system for sending layered media over a plurality of links, the system comprising:
a Priority Scheduler,
a MLDP coupled to the priority scheduler, and
a plurality of wireless modems coupled to the MLDP.

7. The system of claim 6, wherein a first of the plurality of wireless modems connects to a network of a first operator.

8. The system of claim 7, wherein a second of the plurality of wireless modems connects to a network of a second operator, and wherein first operator and second operator are not the same.

9. The system of claim 6, wherein the priority scheduler prioritizes BL packets over EL packets.

10. The system of claim 6, wherein the MLDP fractures BL packets.

11. The system of claim 10, wherein the MLDP assigns a fracture of a BL packet to an available wireless modem.
